(19) United States
(12) Patent Application Publication
(10) Pub. No.: US 2009/0205046 A1
(43) Pub. Date: Aug. 13, 2009

(54) METHOD AND APPARATUS FOR COMPENSATING FOR AND REDUCING SECURITY ATTACKS ON NETWORK ENTITIES

(75) Inventors: Svetlana Radosavac, Sunnyvale, CA (US); James Kempf, Mountain View, CA (US); Ulas C. Kozat, Santa Clara, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: DOCOMO Communications Laboratories USA, Inc., Palo Alto, CA (US)

(21) Appl. No.: 12/270,760

(22) Filed: Nov. 13, 2008

Related U.S. Application Data
(60) Provisional application No. 61/028,502, filed on Feb. 13, 2008.

(51) Int. Cl. G06F 21/00; G06F 11/00

(52) U.S. Cl. 726/23

(57) ABSTRACT

Security attacks on network entities can be compensated for and reduced through insurance that modifies incentives. In one example, a virtual slice provider includes a secure and non-secure slice having resources to provide network access to users through a service provider. The secure slice is assigned a first security level and a non-secure slice is assigned a second lower security level. In one embodiment, the second slice is isolated from the first slice. The virtual slice provider also has a risk policy between the slice provider and the service provider to establish different rates charged to the service provider for access to the secure and non-secure slices and to provide different levels of payment to the service provider for losses resulting from a lack of security in each slice.

### PRIORITY

The present patent application claims priority to and incorporates by reference the corresponding provisional patent application Ser. No. 61/028,502, titled, “A Method and Apparatus for Recovering from and Preventing Security Attacks on Network Entities,” filed on Feb. 13, 2008.

### FIELD OF THE INVENTION

The present invention relates to the field of internet communications; more particularly, the present invention relates to managing risks between users and providers using virtualization.

### BACKGROUND OF THE INVENTION

The Internet has become a fundamental part of life during the last decade and it has become of essential value to companies as well as to individual users to maintain stability of services that we rely upon on a daily basis. More than one billion people use the Internet and critical industries like the banking heavily rely on it. However, the Internet was built under assumptions that don't hold anymore: that all users of the network could be trusted and that the computers linked by the Internet were fixed objects. Hence, the Internet lacks inherent security architecture. Protections like firewalls and antispam software are add-ons and can be considered only as patches used until a real solution is found. The Internet has become just like the real world: both good and malicious individuals have access to it. However, unlike in the real world, it has become increasingly difficult to identify and trace the Internet users. As a consequence, malicious individuals have a strong incentive to shift their illegal activities to the Internet, where they can access more people in a shorter time period, while minimizing their chances of being discovered. As a result, the Internet's security problems are getting worse and at the same time society's dependence on the Internet's security is deepening.

One of the main problems of the current Internet is that the end users bear the complete cost of the attacks. ISPs or infected users do not carry any responsibility. None of the existing schemes that deal with DDoS attack prevention completely eliminates the risk. Even if one user protects itself from becoming a victim of an attack, this does not completely eliminate the risk due to the fact that each user needs to interact with numerous users with different security measures on a daily basis.

One of the most threatening attacks in the current Internet is the Distributed Denial-of-Service (DDoS) attack, which aggregates data traffic from several thousand computers and directs it to a victim web site, essentially causing the web site to be cut off from the world and stop functioning. FIG. 1 illustrates the basic network architecture of a common type of DDoS attack. There are three separate stages of such a common type of DDoS attacks. During the first stage, an attacker 11 chooses a victim (target server 12) and recruits a group of attackers (called masters 13-1, 13-2 . . . 13-n).

During the second stage, the master computers locate and infect vulnerable machines (i.e. computers without effective firewalls, or with newly discovered vulnerabilities, or unprotected machines) by installing flooding servers on them. This stage results in creation of an army of zombie computers 14, i.e. machines that can be controlled by the masters 13. The zombie machines belong to different networks (not shown) and connect to the Internet through various Internet Service Providers (ISPs not shown). During the final stage of the attack, better known as the flooding stage, master computers issue a command that activates zombie computers which flood the victim with a high volume of traffic. If successful, such an attack essentially blocks every path from the victim to the Internet.

Attackers can also hide the identity of infected machines by spoofing the source address field in packets sent by the infected machines. However, except in a few limited situations, such as reflector attacks, spoofing is not a mandatory part of DDoS attacks. It is used for delaying identification of infected machines and prolonging the effects of DDoS attacks.

By using reflectors, a master computer can achieve an effect that is significantly more powerful than if only address spoofing was used. In this case, a single master computer can flood the victim with traffic from more than one million sources.

The group of computers controlled by a single master computer is called a botnet (robot network, i.e. a network of “robot” computers controlled by a master computer). The main purpose of botnets is to use zombie computers for various fraudulent online activities. One significant problem when it comes to detection of botnets is that many owners of infected computers do not know that their machines have been compromised. Although botnets can be used for various types of illegal activities, in the present description, DDoS attacks that originate from botnets are emphasized.

The functionality of botnets would be significantly disrupted if (i) users paid more attention to their own security and (ii) businesses invested more into security and education of their own users. However, this is often not the case. Due to the current state of the Internet architecture, only the target of DDoS attacks bears the cost of the attack. Neither the infected users nor the ISPs bear any of the cost and therefore do not have any short term incentive to invest into security measures. However, this results in a paradox: it is widely accepted that defeating DDoS attacks will be beneficial to e-business given the huge loss these attacks incur; on the other hand, organizations are still reluctant to establish the defense given the costs and additional education they impose for their implementation.

Thus, managing security risks in the Internet has so far mostly involved methods to reduce the risks and the severity of the damages. Those methods (such as firewalls, intrusion detection and prevention, etc.) reduce but do not eliminate risk, and the question remains on how to handle the residual risk. Current schemes applied by Internet Service Providers (ISPs) penalize the users, who suffer from the consequences.

### SUMMARY OF THE INVENTION

A method and apparatus is disclosed herein for compensating for and reducing security attacks on network entities. In one example, a virtual slice provider includes a secure and non-secure slice having resources to provide network access to users through a service provider. The secure slice is assigned a first security level and a non-secure slice is assigned a second lower security level. In one embodiment, the second slice is isolated from the first slice. The virtual slice provider also has a risk policy between the slice provider and the service provider to establish different rates charged to the service provider for access to the secure and non-secure slices and to provide different levels of payment to the service provider for losses resulting from a lack of security in each slice.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of a computer network to show a common taxonomy of a distributed denial-of-service attack.

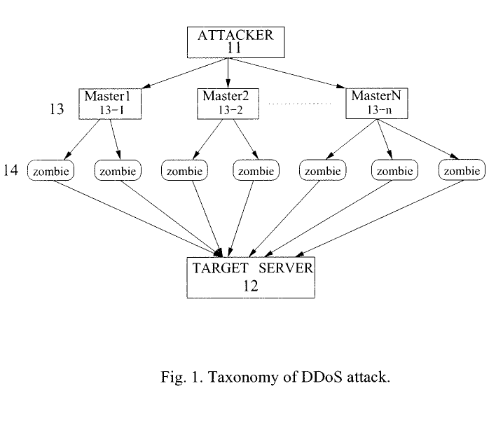

FIG. 2 is a graph to diagram a risk pooling strategy.

FIG. 3 is a graph to diagram a risk pooling strategy in which all risk types are offered the same policy.

FIG. 4 is a graph to diagram a risk pooling strategy in which different risk types are offered different policies.

FIG. 5 is a graph to diagram a risk pooling strategy in which users are offered different policies and equilibrium is established.

FIG. 6 is a block diagram of a virtual slice provider providing access to users through a network service provider according to an embodiment of the invention.

FIG. 7 is a block diagram of a computer system.

### DETAILED DESCRIPTION OF THE PRESENT INVENTION

A method and apparatus for compensating for and reducing security attacks on network entities are described. The techniques described herein transfer a portion of the risk to all the participants. The risk can be handled by re-arranging the economic incentives and transferring some part of the cost of attack to all involved parties, which is in contrast to the current system in which the attack target bears all the cost. According to embodiments of the present invention, such risks are managed by buying insurance against it and consequently re-arranging the incentive chain.

The description that follows is presented in the context of DDoS attacks against Internet users. The losses experienced by users can be significant for businesses that are denied use of sales, manufacturing, and marketing systems. However, there are a wide range of different security risks carried through the Internet and also through private networks. Internet risks can be transferred to private networks and risks can be originated on private networks to affect just that network or to be propagated to all connected networks including the Internet. Embodiments of the present invention can be applied to public and private networks and to a wide range of risks including viruses, spyware, Trojan horses and different types of bots. The variety of risks and their severity continuously change as technologies are developed. All of these risks and their resultant losses can be mitigated using the approaches described below.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

### Overview

For purposes herein, two types of entities exist, namely ISPs and users, where their goal is to maximize their gain while minimizing their losses. It is assumed that the users are aware of the risks involved when they interact with other users and would like to insure themselves and minimize their own losses. On the other hand, the main goal of ISPs is to avoid losses due to attacks and have their insurance costs covered by premiums from users, while earning a profit for their shareholders. A framework is described herein that uses insurance mechanisms that bring profit to the ISPs while protecting the users from risks. In this framework, the ISPs offer certain types of insurance to the users in exchange for certain levels of insurance premiums. Two types of users are assumed: high risk users and low risk users, where the terms “high” and “low” define the probability that a certain user will seek a payment from the insurer. More specifically, a high risk user is more likely to ask for an insurance claim payout than low risk user. In other words, the high risk user is more likely to experience a loss against the policy and make a claim for compensation or indemnity based on that loss. However, more types of users may be used, depending on the particular circumstances.

Each user is assumed to have a wealth was a result of his Internet connectivity and activity. When this wealth is not insured, there exist two possible outcomes for the user. If the user doesn't suffer any damage, the user's wealth will still remain equal to w and the user's utility will be U(w). On the other hand, if the user does suffer damage, the user's wealth will be reduced to w−d and the user's utility will be U(w−d). In one embodiment, the user's expected wealth, E(w) is determined based on the probability p of damage occurring and is given by:

E(w)=p(w−d)+(1−p)w

and the user's expected utility is given by:

EU(N)=pU(w−d)+(1−p)U(w),

where N in U(N) stands for utility when no insurance is offered.

Now consider the case with insurance offered, where an individual purchases an insurance premium at price α₁. Hence, the initial wealth of a user is equal to w−α₁. In the case of an attack, the ISP acting as an insurer pays out an amount of money equal to α₂ and consequently the resulting wealth of an insured individual after the accident is equal to w−α₁−d+α₂. The user's expected utility in this case can be expressed as:

EU(I)=pU(w−β)+(1−p)U(w−a₁),

where β=α₁+d−α₂ and I in U(I) stands for utility when insurance is offered. The payout insurance premium α₂ can be a function of both the insurance premium a₁ and the probability p that individual users will make an insurance claim. The vector a α=(α₁, α₂) defines an insurance contract between the ISP as an insurer and the user.

Furthermore, the following notation is used for purposes herein:
w₁: final wealth of the user without attack
w₂: final wealth of the user after the attack
   Assume that a user will have an incentive to buy an insurance policy if the expected utility of being insured exceeds the expected utility of being uninsured. Combining Eq. 2 and Eq. 3, provides the following inequality:

pU(w−β)+(1−p)U(w−α₁)>pU(w−d)+(1−p)U(w)

In one embodiment, the ISPs do not implement any kind of outbound traffic control and the only type of traffic control implemented is the standard inbound traffic control. As explained below, the techniques described herein provide benefits regardless of the types of traffic control implemented by ISPs and other participants in the network. The insurance architecture described below provides an incentive for both ISPs and users to increase the security of the network.

For purposes herein, the following definitions are used. However, the specific parameters of any system may be adapted to suit the particular circumstances:
an insurance policy represents a contract of insurance, describing the term, coverage, premiums and deductibles. More specifically, an insurance policy represents a set of payment and compensation rules enforced between the buyer and the provider of the policy;
an insurance contract defines the set of rules under which the features of an insurance policy are enforced; and
an insurance premium represents the periodic payment made on an insurance policy, i.e. an amount of money a user pays to an insurance company regardless of whether the user has had a claim or insured event. As explained below, in one embodiment, a policy is offered that encourages good behavior and is enforceable by regulatory dynamics.
   Also, for purposes herein, it is assumed that both the users that access services through ISPs and the ISP have the goal of making a profit, while minimizing the risks involved. However, the architecture of the present invention may also be applied to other situations and conditions. In the case of users, this goal can be expressed as minimizing the decrease of initial wealth w. In one embodiment, the general policy of the ISP is to formulate its pricing policies so that in the case of a DDoS attack (i.e. in the case when all participants will suffer damage and will ask for insurance payout), the ISP does not obtain negative profit. More specific objectives are discussed below.

### ISP Insurance Policies

As mentioned above, a user cannot eliminate the risk by only protecting himself partially due to the fact that new threats, for example a new OS vulnerability, appear and propagate with high speed, and partially due to the fact that both ISPs and users interact with each other and thus they are highly dependent on each other's conditions. Even though significant resources are being invested into security, the Internet users and services are still extremely vulnerable

For simplicity, in one embodiment, only two types of users are considered in this architecture: high and low risk, however many more types may be considered. The user is classified as either low or high risk depending on one or more factors. In one embodiment, these factors include one or more of the following: profitability of its business (more successful businesses are more likely to be a target), publicity of the user (better known and more controversial users are more likely to be a target), whether or not the user deals with sensitive and important data etc. In that light, each user is classified as either high or low risk. More specifically, for purposes of this example, the two types of users can be defined as follows:
H: with probability of claiming insurance Pₕ
L: with probability of claiming insurance Pₗ
   where Pₕ>Pₗ.

By introducing insurance, part of the risk is transferred to the ISP. In the case of a DDoS or other attack, the ISP compensates for the damages of users who pay insurance. As to ISP profit, each of the insurance policy examples attracts certain portions of low and high risk customers. The architecture described herein includes a policy that: (i) is acceptable for users (brings satisfying level of compensation for an acceptable insurance premium) and ISPs (brings them profit); (ii) can survive in the competitive market (i.e. is stable).

In networks, there are two possible scenarios:

1) lSPs cannot identify high and low risk users and all risk types are offered the same policy.

2) ISPs can identify both classes of users and offer different policies to each type.

### All Risk Types Purchase the Same Insurance

In addition to the above, assume that all users know their own risk type Pᵢ, but this information is not available to the companies, such as ISPs and insurance carriers. This setup is more realistic because users in general know more about their risk type than the insurance companies. This claim is true even in the case of uneducated users. Namely, even though they do not know how insecure they are, they are aware that they are not using any security measures to protect themselves from becoming a victim.

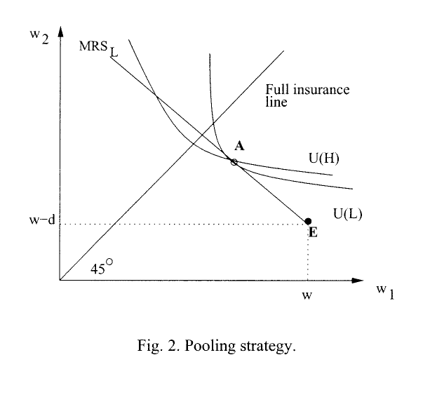

In this scenario, both high and low risk users are offered the same policy due to the ignorance of ISP which is not capable of pinpointing different types of users. This scenario exists in the case when the insurance agent is ignorant about the user's risk types and consequently chooses to offer the same policy for all the users. This scenario is the basis for the diagram of FIG. 2, where the x-axis represents the wealth of the user before the attack and the y-axis represents the wealth of the user after the attack. The point E in FIG. 2 represents the endowment point. In case of no loss, a user remains with wealth w (x-axis), and in case of attack, a user remains with wealth w−d (y-axis) at point E. A user will typically not want to purchase insurance to arrive at point E.

Considering FIG. 2 in more detail, curves U_{H} and U_{L} represent indifference curves for high and low risk users respectively. Namely, all points at U_{H} (U_{L}) yield the same utility for high (low) risk users and as a consequence a user is indifferent between the choices that lie on the same curve. The slope of the indifference curves represents the MRS (Marginal Rate of Substitution, i.e. rate at which consumers are willing to substitute one good for the other). In this case the one good is the insurance policy premium and the other good is the coverage against claimed losses offered by the policy. The optimal operating point A (from the point of expected utility) is where the indifference curve is tangent to the MRS line.

Both types of users have the same preferences, but their indifference curves have different slopes at any point in the state space diagram since they face different probabilities of presenting claims against the insurance premiums. The line MRS_{L} in FIG. 2 represents the market average fair odds line. The market average fair odds are the odds that an insurer (ISP) could offer to the average customer while breaking even on average as long as the contract was accepted by a random sample of both types of customers, high risk and low risk.

Looking at what the market average fair premium represents, the insurer will be driven by market demand to offer the policy that optimizes the welfare of the low risk customers. This policy is represented with point A in FIG. 2. Any contract below MRS_{L} would offer extra profits to the insurer if it could attract both types of customers. This kind of contract cannot be at equilibrium since competition would drive the contract to improve until it again reaches a point that lies on MRS_{L}. Let's now examine what happens if an insurer offers a contract to the right of A along MRS_{L}, in other words, a contract closer to the endowment point, higher on the horizontal axis and lower on the vertical axis. That contract could always be improved by another insurer offering a contract at A since both risky and non-risky customers prefer that contract. Similarly, if an insurer offered a contract on the left side of A along the MRS_{L} that contract could always be improved by offering a contract at point A (only the low risk customers will prefer the contract at point A and thus it would attract all the safe types, with all the high risk types remaining with the contract at the point at the left side of A).

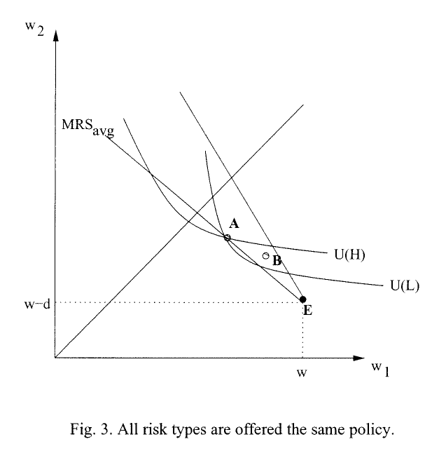

No contract like the one illustrated in FIG. 2 at point A may be feasible since adverse selection occurs and only the risky customers purchase insurance. This case is illustrated in FIG. 3, which can be used to demonstrate that the FIG. 2 scenario offers no equilibrium state. Assume that an insurance company offers a contract A along the MRS_{L} line shown in FIG. 2 and FIG. 3. However, at that point, the indifference curve for the low risk customer, U(L), is always steeper than the one for the high risk customer U(H) through point on the MRS_{L} line. Thus it is always possible for an insurance company to improve upon the existing contract A by offering a policy represented with point B in FIG. 3.

Point B in FIG. 3 lies strictly below U_{H} so clearly high risk users are happier with the current policy at point B. However, low risk users strictly prefer this policy, since B is above U_{L}. Hence, point B is a better deal. On the other hand, it doesn't provide as much insurance because it lies closer to E than does point A. This is attractive to low risk users because they would rather have a little more money and a little less insurance since they are cross-subsidizing the high risk user types. For the opposite reasons, high risk users prefer the initial policy, where they were cross-subsidized by low risk users. As a consequence, when policy B is offered, all low risk users change to B and the high risk types stick with A. Now, policy B is profitable if it attracts only low risk users because it lies below the MRS_{L} line. However, the insurer that offers policy A is now in the sub-optimal position: it attracts only high risk customers.

Consequently, equilibrium does not exist in the setup suggested by FIG. 3. It is always destroyed by a new policy that attracts low risk customers from the pool of users. This causes the existing policy to lose money because only high risk users remain and the insurance disappears. In other words, the ISP that offers this policy disappears from the market since it cannot attract a variety of different users. Consequently, contract A fails and the whole pool of users is again attracted to the same point, this time point B. Now, there may again be another insurer that will offer a new policy, say C, that is better than B which will again attract good users and the cycle will repeat. However, as the offered policies move closer to the endowment point E, the gains of new contracts are smaller and eventually either there will be no insurance policies offered since ISPs will not be able to gain anything or a different policy will be offered.

Summing up FIGS. 2 and 3, if a company loses money on one group of users and profits on the other, there is a strong incentive to separate the two groups and charge different prices for insurance. This suggests the notion of separating equilibrium, where each risk type buys a different policy.

### Each Risk Type Buys a Different Policy

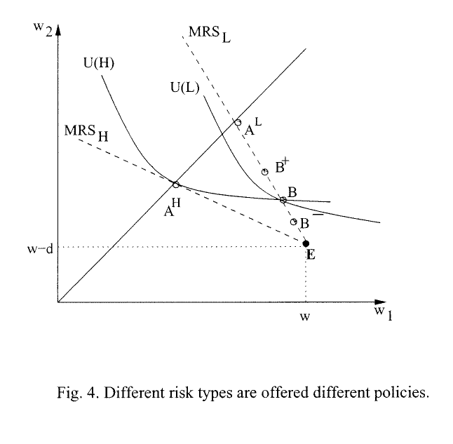

The situation in which all the users are offered the same policy can become infeasible as soon as an informed insurer enters the market, resulting in a strict separation of low and high risk users. If one or more ISPs decide on a policy where they offer fixed insurance premiums for all users, they eventually attract primarily the high risk users. In the scenario illustrated in FIG. 4, points A^{L} and A^{H} are the full-insurance points for the two risk groups. FIG. 4 also shows two MRS average lines, a MRS_{L} line for the low risk group L, and an MRS_{H} line for the high risk group, H. The two lines meet at the endowment point and the slope of the average MRS is steeper for Group L. Group L also has higher wealth because its odds of experiencing a loss are lower.

The point labeled B on the MRS_{L} line represents the point where the utility curve from the high risk group seeking full insurance crosses the MRS_{L}, the marginal rate of substitution curve from the low risk group B is the best policy that can be offered to low risk users that would not also attract high risk users because it is on the high risk user indifference curve U(H). If an ISP offered another policy, say B⁺, low risk users would strictly prefer it. However, the high risk users would also prefer this policy, resulting in a single policy scenario, the non-sustainable or non-equilibrium scenario above. If an ISP offered a policy B⁻, high risk users would not select it, but low risk users would strictly prefer the original policy at B. Hence, any policy like B⁻ is dominated by B. So, B is the point that defines the separating constraint for low and high risk users. Any policy that is more attractive to high risk users would converge to the single policy scenario suggested by FIGS. 2 and 3.

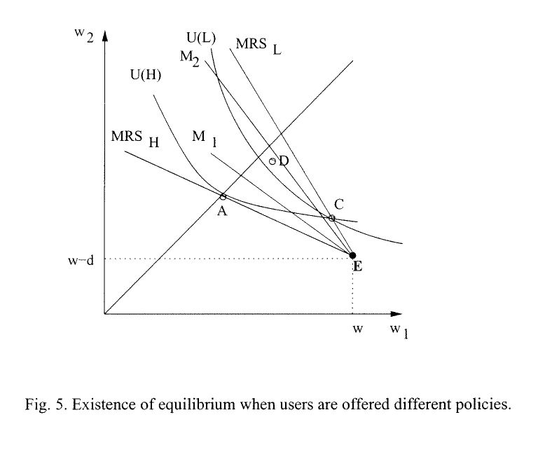

FIG. 4 suggests a scenario in which the ISP offers two types of policies: A^{H} and B, where A^{H} is the best policy for high risk users and B is the best policy for low risk users. With this insurance scenario, high risk users are fully insured and low risk users are offered partial insurance. As explained above, if a company offers a policy that fully insures the low risk users, it would also attract the high risk users. Hence, preferences of high risk users act as a constraint on the market. The insurance companies must maximize the well-being of low risk users subject to the constraint that they do not attract high risk customers. For that to occur, the proposed policies must be in equilibrium, as FIG. 5 illustrates.

In the scenario, the market fair odds line, M₁, lies below the low risk customer's indifference curve U(L) through C. In this case, any contract capable of attracting low risk users away from C would also attract high risk users from A and lie above the market average fair odds line, MRS_{H}, thus introducing a premium below the market average fair odds premium and producing expected losses for the insurer. An insurer (ISP) faced with competitors offering the separating contracts could do no better than to offer those contracts itself and can find no other contract to offer which produces supernormal profits; the separating contract therefore represents Nash equilibrium.

FIG. 5 also includes a line M₂. If the market fair odds line were represented with M₂, then the market fair odds line would cut the low risk user's indifference curve at point C. This scenario may arise in the case when there exists a higher proportion of safe customers in the market. If the indifference curve and market fair odds line cut in this way, it is always possible to find a new contract to offer that is capable of attracting both high and low risk customers away from the separating contract. This contract is denoted as D in FIG. 5. Since D lies above the indifference curves for low and high risk users, the contract attracts both types of customers away from the separating contracts. Also, since D lies below M₂, the contract charges a premium higher than the market average fair odds premium, thus yielding positive expected profits to the insurer (ISP). An ISP faced with competitors offering the separating contracts will not maximize profit, given the actions of his competitors, by offering separating contracts, but will do better to offer the contract allowing customers to locate at point D. The separating contracts, therefore, do not produce a Nash equilibrium in this case.

The contract located at point D is the same one as the one analyzed in FIG. 2. It was shown that no such contract ever produces a Nash equilibrium in this case. It follows then that no Nash equilibrium exists in the latter case. However, at the separating equilibrium, the low risk users are not fully insured and they may be unhappy therefore. A policy like D that requires just a little cross-subsidy to high risk users but offers more insurance may be preferred by low risk users to policy C. Hence, if there are sufficiently few high risk users in the market, an ISP could profitably offer this policy and it will dominate the two separating policies. In this scenario low risk users prefer more insurance at an unfair price to less insurance at a fair price. This can be true if there are many low risk users compared to high risk users over which to spread the risk, allowing the price to be only moderately too high. However, the market cannot tolerate this scenario, as shown above.

As demonstrated using the diagrams above, there is no obvious guarantee for the service provider that his insurance business plan will be successful. The internet architectures discussed above do not provide any incentive for the ISPs to protect their users from attacks, i.e. offer them some kind of compensation. If the main goal of ISPs is to make profit and the main goal of users is to be protected from attacks (maintain the majority of their wealth even in the case of attacks), then an insurance scenario, where part of the risk was transferred to the ISPs would seem reasonable. However, as explained above, by using only insurance, ISPs have no guarantee to make a profit and consequently have no incentive to implement schemes using simple insurance scenarios. Accordingly, ISPs in order to profit from insurance will converge toward more secure schemes, in which they transfer their residual risk to a third party.

### Virtualization Models Systems and Architectures

As explained above, neither insurance scheme offers strong security guarantees to users that purchase the policy, while remaining profitable for the ISP at all times. In addition, the introduction of competition in the market (i.e. several ISPs competing for customers and offering different types of insurance) leads to a natural separation of high and low risk users. A stricter framework for regulating user behavior can be obtained by introducing virtualization. Virtualization introduces a new entity referred to herein as a VSP (Virtual Slice Provider). The VSPs interact with ISPs in new insurance scenarios.

The VSP provides access to virtual slices. These slices include data centers, routers, switches, and any other network access resources. In one embodiment, each slice is configured to include some measure of guaranteed access to slice resources, such as memory, CPU time, link speed, etc. For each slice, these resources can be dedicated and isolated so that risks from one slice do not directly affect risks from other sources. In one embodiment, a VSP subjects different slices to different security levels.

In a completely virtualized network, all devices and links are divided into virtual slices. Such a network can be public or private or mixed. In one embodiment, for a non-distributed approach, slices are assigned, usually in response to a user request that is directed to a control node (CN) managed by an ISP.

The different slices allow ISPs to separate different types of users by using different slices for users of different risk types. The different slices also allow the ISP to be charged different insurance premiums depending on the risk that its users present and the security level of a slice. The ISP, in order to minimize its insurance premiums can then observe the behavior of its users and for high risk users increase the insurance premiums or terminate access. As a result, the insurance premium imposed on a user by an ISP tends to be a function of the estimated risk level of the user pool that the ISP attracts.

The VSP in the same way classifies ISPs based on risk level and adjust insurance premiums based on the risk level. The VSP can then terminate access to secure slice to a particular ISP if it estimates that a particular ISP brings too much risk.

As explained above, an equilibrium exists only when an ISP's policy attracts both low and high risk users. If the population is mostly low risk, the offered equilibrium is profitable and the policy will be offered. Here, an alternative version of this scenario, where an ISP offers a policy that attracts mostly low risk users, but has a certain portion of high risk users is more fully described.

The nature of the Internet typically involves continuous interactions between multiple users that belong to multiple ISPs. Therefore, in some models two conditions are met:

1) The ISP needs to be held partly accountable for the behavior of its users

2) Each VSP needs to know the risk level of the ISPs it is interacting with. Given that information, it classifies ISPs as high or low risk and charges appropriate insurance premiums.

For the system model in accordance with some embodiments of the present invention, the following entities are contemplated, however more or fewer and different entities may be considered depending on the circumstances:
users, who can be either highly secure (high risk) or non-secure (low risk);
services, that can be either high risk or low risk;
ISPs, which offer certain types of insurance to users; and
virtual slice providers (VSPs) who provide slice access to certain types of users. In the present example, VSPs host both users and service; however, this is not necessary to the invention.

From the point of view of DDoS attacks, highly secure users are users that invest into their own security measures and are knowledgeable about possible dangers involved in internet activities. Hence, this class of users is less likely to become infected and consequently become a part of a botnet. On the other hand, non-secure users are either not knowledgeable and are unable to protect themselves from dangers or are not interested in investing into their own security.

High risk services can be characterized as more likely to be a target of DDoS attacks than low risk services. Consequently, high risk services need more protection. It is assumed that the VSP has the right to terminate access to secure slices in case it estimates that the ISP brings too much risk to other users and services that have access to the secure slice. In addition, for this model, ISPs monitor inbound traffic; however, this is not required. In one embodiment, to minimize the probability of originating an attack, the ISPs that are granted access to a secure slice have an obligation to monitor outbound traffic as well. Otherwise, if no such control was implemented and the attack happens, the VSP will have an incentive to deny further access to the secure slice to the ISP that was the originator of the attack. In addition to that, the VSP would have to pay out insurance premiums to all its users and services due to the fact that they lost connectivity. Hence, there is enough motivation for mandatory implementation of outbound traffic control for accessing the secure slice.

In one embodiment, an ISP that performs both inbound and outbound traffic control is granted access to a secure slice. Otherwise, if only inbound traffic control is performed, an ISP is granted access to a regular slice only. An ISP that accesses a secure slice needs to offer low risk insurance policies to its users, and only users that pay for insurance are allowed on the secure slice. High risk slices can accommodate both users that do not buy insurance (and may also not self-protect) and users who choose to transfer their residual risk and buy high risk insurance, but there is no requirement on ISPs to offer insurance for access to a high risk slice, just as in today's Internet. In addition, ISPs must enforce additional protections on the low risk slice, such as restrictions on access to users whose self-protection measures are up to date and are not infected, and outbound traffic control to ensure that they do not originate any attack traffic.

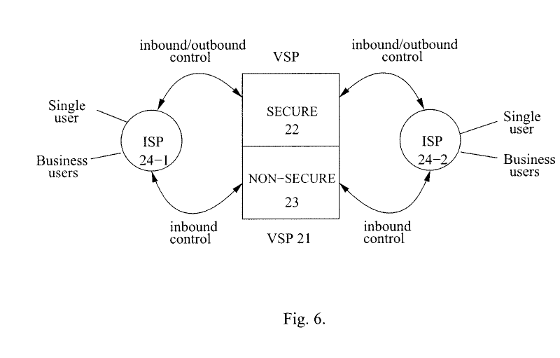

FIG. 6 is a block diagram of a portion of a network architecture suitable for implementing the insurance schemes described. Referring to FIG. 6, a VSP 21 has a secure slice 22 and a non-secure slice 23, which has the same properties as the current Internet Two slices are shown for simplicity, an actual system may have many more slices, many more ISPs and many more users or subscribers. The slices are accessed by ISPs 24-1, 24-2. Access to the slices is provided to users through the ISPs. In FIG. 6, there are business users 25-1, 25-2, and single users 26-1, 26-2. As shown, there is inbound and outbound traffic between the ISPs 24-1 and 24-2 and the secure slice 22. While the ISPs are shown as accessing only a single VSP, an ISP may obtain resources from one or more VSPs and VSP may provide slices to one or more ISPs. It is contemplated that many of these connections will be covered by an insurance policy, however, an ISP may choose to operate in part without insurance and in part using its own resources (self-insured).

Accordingly, it is in the interest of ISPs in this scenario to implement strict outbound traffic control for accessing the secure slice. In case the ISP observes abnormal behavior of a certain user, it will either increase its insurance premium or completely terminate its access (to reduce the probability of becoming a source of an attack and being denied access to the secure slice 22 by the VSP 21). Thus, the architecture described herein provides incentive to users to take certain security measures and incentive to the ISPs to perform a tighter control of user's activities.

Embodiments of the present invention can be considered in the context of the following general insurance model. The insurance premium imposed on ISPᵢ (the i^{th} ISP) is a function of the estimated risk level of the user pool ISPᵢ attracts. The proposed virtualization architecture removes the problem of asymmetric information (i.e. that the ISP doesn't know the users' self protection levels while the other users do) that arises in the previous setting, where no virtualization architecture is implemented. In the previous setting. The ISPs determine the premiums according to average risk and are not able to classify users prior to selling insurance premiums. In the virtualized setting, VSPs observe the behavior of a candidate ISP, its interactions with other ISPs as well as actions of its users and after a predetermined period of time they assess the risk of a given ISP (i.e. the probability p) and offer a corresponding insurance premium. Therefore, it is in the interest of an ISP to enforce strict user enrolment policies and control of outbound traffic. In this way, each ISP monitors the behavior of its users and determines whether the user is secure or non-secure and determines the insurance premium for that specific user. If a user is determined to be secure, but later changes its behavior, the ISP will change the user's classification into non-secure and charge a higher premium. On the other hand, the ISP determines the risk factor of each service it hosts and charges adequate insurance.

High risk services will want to access secure slices in order to minimize the risk. Note that the control of the outbound traffic helps the efficient functioning of an ISP. Therefore, depending on (i) behavior of its users, and (ii) the number of high and low risk services, each ISP is assigned a certain risk level by the VSP. The VSP then estimates the risk and offers a certain insurance premium to the ISP. Thus, the complete cost to the ISP in this case can be represented as:

C_{ISP}=Insurance premium(R_{ISP})+C_{A}+C_{O},

where R_{ISP} represents the estimated risk of an ISP, C_{A} represents the slice access cost and C_{O} represents the management cost of outbound traffic and other security measures. On the other hand, the VSP needs to impose an insurance policy that will compensate for (i) the cost of a potential DDoS attack and (ii) the slice management costs.

The first item, the cost of potential DDoS attack, carries the most risk. VSPs have an incentive to apply strict user enrolment policies. ISPs also have an incentive to access slices of higher security.

As a result, the cost imposed to each VSP can be expressed as follows:

$${C}_{VSP} = {\sum }_{i} Compensation ( D ( i ) ) + {C}_{M} ,$$

where D(i) represents the cost of a DDoS attack originating from ISPᵢ and C_{M} represents the management cost of virtual slices. On the other hand, the gain of the VSP can be defined as

$${G}_{VSP} = {\sum }_{i} Insurance premium ( {R}_{{ISP}_{i}} ) + {\sum }_{i} {C}_{A} ,$$

where the first item in the equation represents the sum of all insurance premiums (a function of estimated risk) paid by all ISPs that access a certain slice and the second item represents the sum of all slice access charges collected from all ISPs.

This scheme combines virtualization and insurance mechanisms for managing the risks involved in the current Internet. Such a model may also be applied to any other type of risky network. By introducing virtualization a strict control of user behavior can be imposed and incentives are provided for users to take certain security measures when accessing the Internet. The information asymmetry is removed in ISP-VSP interactions, enabling successful management of residual risk imposed by the inability of ISPs to assess the risk of their customers. The high risk slice provides an opportunity for ISPs and their users to offer exactly the same service with exactly the same lack of security guarantees for customers that don't want to pay a premium for more secure service. The proposed architecture provides stringent security guarantees (which include connectivity) for all users that are granted access to secure slices. As a consequence: (i) users now have incentive to invest into their own security (this will result in decreased insurance premiums) and (ii) all the ISPs have the incentive to control the behavior of their users (this will result in larger profit since ISPs will suffer low or no losses from low-security users and will charge premiums for accessing highly secured slices).

Embodiments of the present invention provide an economically viable insurance market solution that can separate different types of users over a virtualized network. The virtualized network described above with multiple slices is used to separate users of different risk types. Different self-investment incentives and insurance policies further reduce and manage the residual risk. This architecture applies economic principles to decrease the risk of DDoS and other types of attacks while providing incentives for good behavior.

The virtualized network as presented in the present description presents an effective way to estimate risk. The virtualization architecture ensures better risk evaluations and better (more realistic) insurance premiums offerings. The multiple slices allow users of different risk types to be separated. In one example, an insurance business model can survive because users that access the secure network remove information asymmetry. This results in lower insurance premiums because the risk can be estimated correctly, offering higher security to users.

The virtualization architecture can be further enhanced by offering different self-investment incentives and insurance policies to further reduce and manage the residual risk. The overall system may have no impact on users that do not have strict security requirements. These users can continue operating as before (with the same risks as before).

On the other hand, high risk users with strict security requirements can be offered incentives to adopt good security practices such as lower insurance premiums and damage compensation in case of attack.

In the virtualized network described above, there is a variety of different possible configuration. A VSP can lease separate and isolated network slices to ISPs. In this setting, each network slice can be configured with different inbound and outbound traffic monitoring, user monitoring, and security properties. Each slice can also be accompanied by a different insurance policy. ISPs can lease one or more slices based on their own customer profiles. Network access providers (or Slice Managers) grant different access privileges and insurance policies to individual ISPs based on their conformance to the slice security and the risk they bear for the slice. Using virtualization more strict user control can be imposed because ISPs now know the risk of other users. In addition, some of the cost of potential distributed denial of service attacks is distributed to the ISPs, who are now incentivized to impose additional traffic control, user control, monitoring, and tracing.

Embodiments of the invention provide a novel, incentive based, method for prevention of attacks and mitigation of the effects of DDoS attacks. This can be used together with traffic filtering and other already existing attack prevention methods.

### An Example of a Computer System

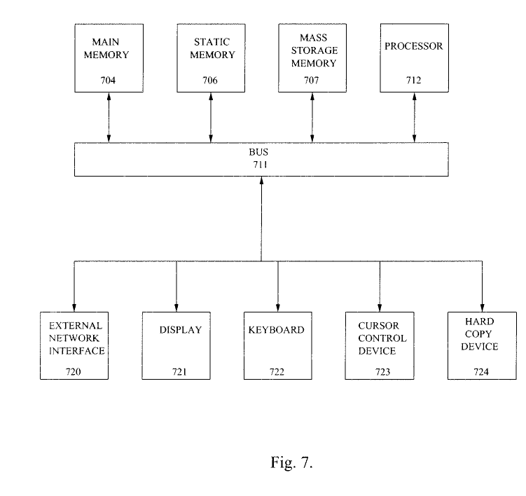

FIG. 7 is a block diagram of an exemplary computer system that may perform one or more of the operations described herein. Referring to FIG. 7, computer system 700 may comprise an exemplary client or server computer system. Computer system 700 comprises a communication mechanism or bus 711 for communicating information, and a processor 712 coupled with bus 711 for processing information. Processor 712 includes a microprocessor, but is not limited to a microprocessor, such as, for example, Pentium™, PowerPC™, Alpha™, etc.

System 700 further comprises a random access memory (RAM), or other dynamic storage device 704 (referred to as main memory) coupled to bus 711 for storing information and instructions to be executed by processor 712. Main memory 704 also may be used for storing temporary variables or other intermediate information during execution of instructions by processor 712.

Computer system 700 also comprises a read only memory (ROM) and/or other static storage device 706 coupled to bus 711 for storing static information and instructions for processor 712, and a data storage device 707, such as a magnetic disk or optical disk and its corresponding disk drive. Data storage device 707 is coupled to bus 711 for storing information and instructions.

Computer system 700 may further be coupled to a display device 721, such as a cathode ray tube (CRT) or liquid crystal display (LCD), coupled to bus 711 for displaying information to a computer user. An alphanumeric input device 722, including alphanumeric and other keys, may also be coupled to bus 711 for communicating information and command selections to processor 712. An additional user input device is cursor control 723, such as a mouse, trackball, trackpad, stylus, or cursor direction keys, coupled to bus 711 for communicating direction information and command selections to processor 712, and for controlling cursor movement on display 721.

Another device that may be coupled to bus 711 is hard copy device 724, which may be used for marking information on a medium such as paper, film, or similar types of media. Another device that may be coupled to bus 711 is a wired/wireless communication capability 725 to communication to a phone or handheld palm device.

Note that any or all of the components of system 700 and associated hardware may be used in the present invention. However, it can be appreciated that other configurations of the computer system may include some or all of the devices.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims.

We claim:

1. A virtual slice provider comprising:
a secure slice having network resources to provide network access to users through a service provider, the secure slice having a first security level;
a second slice having network resources to provide network access to users through the service provider, the second slice having a second lower security level, the second slice being isolated from the first slice; and
a risk policy between the slice provider and the service provider to establish a first rate charged to the service provider for access to the secure slice and a second rate charged to the service provider for access to the second slice and to provide different payment levels to the service provider for losses resulting from a lack of security in each slice.

2. The virtual slice provider of claim 1, wherein the network resources comprise routers, servers and communication paths to interconnect the routers and servers.

3. The virtual slice provider of claim 1, further comprising one or more additional slices each having a defined security level and wherein the risk policy has a rate for each slice based on the security level of the respective slice.

4. The virtual slice provider of claim 1, wherein the first and second rates are also related to the security practices of the service provider.

5. The virtual slice provider of claim 1, wherein the network is the Internet and the service provider is an Internet Service Provider (ISP).

6. The virtual slice provider of claim 1, further comprising monitoring user access to the secure and second slice and wherein the first and second rate are also related to the security practices of the users based on the monitoring.

7. A network service provider comprising:
a plurality of connections to a plurality of different users to provide connections between the users and the service provider;
a connection to a secure slice of a virtual slice provider, the secure slice having network resources to provide network access to the users through the service provider, the secure slice having a first security level;
a connection to a second slice of a virtual slice provider, the second slice having network resources to provide network access to the users through the service provider, the second slice having a second security level; and
a risk policy between the slice provider and the service provider to establish a first rate paid by the service provider for access to the secure slice and a second rate charged to the service provider for access to the second slice and to provide different payment levels to the service provider for losses resulting from a lack of security in each slice.

8. The network service provider of claim 7, wherein the service provider monitors users to determine risk levels for users, and wherein the first and second rates are based on the risk levels of the users.

9. The network service provider of claim 7, wherein the service provider monitors users to determine risk levels for users, and wherein the first and second rates are adjusted to accommodate the determined risk levels of users.

10. The network service provider of claim 9, further comprising a router to route high risk users to the second slice and low risk users to the secure slice.

11. The network service provider of claim 7, further comprising a risk policy between the service provider and each of a plurality of the users to establish a first rate paid to the service provider for high risk users and a second rate paid to the service provider for low risk users and to provide payments to the users for losses resulting from a lack of security.

12. A method comprising:
routing network access between users and a secure slice through a network service provider, the secure slice having network resources and a first security level;
routing network access between users and a second slice through a network service provider, the second slice having network resources and a second security level; and
charging a first insurance premium to the network service provider for access to the first slice and a second rate to the network service provider for access to the second slice and providing different payment levels to the service provider for losses resulting from a lack of security in each slice.

13. The method of claim 12, wherein the losses are experienced by the users, the method further comprising providing the loss payments to the service provider to users that experience the loss.

14. The method of claim 12, further comprising monitoring the behavior of users and classifying the users based on security levels.

15. The method of claim 14, further comprising routing high security users to the secure slice and routing low security users to the second slice.

16. The method of claim 14, further comprising charging an insurance premium at a first rate to low security users and charging an insurance premium at a second lower rate to high security users and providing payments to the users for losses resulting from a lack of security.

17. A method comprising:
separating a plurality of network users into at least two different security risk types;
providing access to users of a first risk type to a first virtual slice, the first virtual slice comprising routers and servers for network access;
providing access to users of a second risk type to a second virtual slice, the second virtual slice comprising routers and servers for network access;
imposing a first class of insurance premiums on users of the first risk type, the insurance premium providing insurance against losses from a lack of security; and
imposing a second class of insurance premiums on users of the second risk type, the insurance premium providing insurance against losses from a lack of security.

18. The method of claim 17, further comprising monitoring the behavior of the users and changing a risk type of a user based on a changing in behavior.

19. The method of claim 17, wherein the users of the first risk type have a higher risk of losses based on a lack of security and wherein the insurance premiums on the first risk type users are higher than the insurance premiums on the second risk type users.

20. The method of claim 17, wherein providing access comprises providing access through a network service provider and wherein imposing insurance premiums comprises imposing insurance premium by the network service provider, the method further comprising imposing an insurance premium on the network service provider based on the security risk imposed by users corresponding to the network service provider.

21. An article of manufacture having one or more computer readable storage media storing instructions thereon which, when executed by a network, cause the network to perform a method comprising:
routing network access between users and a secure slice through a network service provider, the secure slice having network resources and a first security level;
routing network access between users and a second slice through a network service provider, the second slice having network resources and a second security level; and
charging a first insurance premium to the network service provider for access to the first slice and a second rate to the network service provider for access to the second slice and providing different payment levels to the service provider for losses resulting from a lack of security in each slice.
